(19) United States
(12) Patent Application Publication
(10) Pub. No.: US 2015/0220590 A1
(43) Pub. Date: Aug. 6, 2015

(54) SYNTHETIC UPDATES FOR FILE SYSTEM INFORMATION

(71) Applicant: HGST Netherlands B.V., Amsterdam (NL)

(72) Inventor: Christopher Squires, Boulder, CO (US)

(73) Assignee: HGST Netherlands B.V., Amstedam (NL)

(21) Appl. No.: 14/170,241

(22) Filed: Jan. 31, 2014

(51) Int. Cl. G06F 17/30

(52) U.S. Cl. CPC G06F 17/30377; G06F 17/30356; G06F 17/30174

(57) ABSTRACT

To provide enhanced operation of storage control systems associated with data storage devices, such as rotating media-based hard drives, various systems and methods are provided herein. In some examples, these systems and methods can provide for receiving write requests from a host system to write content elements to storage media in a storage subsystem. In response to the write requests, synthetic updates are generated corresponding to updates to file system information stored in the host system that are representative of the write requests. The synthetic updates are written to the storage media such that each update is stored proximately to the content elements, is non-contiguous with respect to other synthetic updates, and is removed spatially from the version of file system information stored on the storage media.

### TECHNICAL BACKGROUND

Computer and network systems such as personal computers, workstations, server systems, and cloud storage systems, typically include storage control systems for storing and retrieving data. These storage control systems can include storage media, such as hard disk drives, solid state storage devices, tape storage devices, and other mass storage devices.

In examples of storage control systems, such as rotating media hard disk drives, file system information is stored on the storage media. The file system information allows a host system to know the location on the storage media where content elements are located. The file system information is located in a specific location on the storage media to provide information to the host system to access content elements on the storage media. When a content element is modified on a host system, an operating system (OS) may write the content element and file system information immediately. The OS may write the content element first or the file system information first. However, if an emergency power off (EPO) occurs after the content element/file system information is written but before the file system information/content element is written, the storage control system and host system will not have accurate information about the content element or a correct storage location.

An OS may also write each content element to storage media as each content element is modified in the host system but not update the file system information on the storage media until many content elements have been written to the storage media. However, if an EPO occurs after the content elements are written, but before the file system information is written, the storage control system will not have accurate information about the location of the written content elements and information may be lost.

In order to overcome the shortcoming of having the content elements and file system information being inconsistent, some OSs incorporate journaling. The content elements and file system information are written to a journal on the storage media. Once the journal entries have been written, the content elements and file system information are written to the storage media in the proper location. If an EPO occurs before the content elements and file system information are written, the journal entries can be used to recreate the unwritten content elements and file system information.

### Overview

To provide enhanced operation of storage control systems associated with data storage devices, such as rotating media-based hard drives, various systems and methods are provided herein. In some examples, these systems and methods can provide for receiving write requests from a host system to write content elements to storage media in a storage subsystem. In response to the write requests, synthetic updates are generated corresponding to updates to file system information stored in the host system that are representative of the write requests. The synthetic updates are written to the storage media such that each update is stored proximately to the content elements, is non-contiguous with respect to other synthetic updates, and is removed spatially from the version of file system information stored on the storage media.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 is a system diagram illustrating a storage control system.

FIG. 2 is a flow diagram illustrating a method of operation of a storage control system.

FIG. 3 is a system diagram illustrating a storage control system.

FIG. 4 is a sequence diagram illustrating a storage control system.

FIG. 5 is a block diagram illustrating a host system.

FIG. 6 is a block diagram illustrating a storage subsystem.

### DETAILED DESCRIPTION

Examples disclosed herein provide for writing synthetic updates of file system information on a storage control system. When changes are made to content elements in a host system, corresponding updates are made to the file system information in the host system. Rather than updating the version of the file system information on the storage subsystem each time a change is made, synthetic updates can be generated and written proximately to the content elements.

In an operational example, a user makes a change to a file on a host system. By making changes to the file, the host system may update the file system information on the host system or create updates, which need to be made to the file system information. The host system can then write the changes to the storage media for long-term storage. Typically, the storage subsystem would write the content elements of the file at a desired location and update the file system information on the storage media.

In a hard disk drive, this would cause the heads to have to seek to two different locations for each content element written. The first location would be the location of the content element and the second location would be the location of the file system information on the storage media. If many content elements are to be written, a significant portion of time would be consumed seeking back and forth between the file system information location and the content element locations. By writing synthetic updates proximately to the content elements, seek time can be reduced, thereby improving write speed times. By improving write speeds, an emergency power off event is less likely to corrupt data on the hard disk drive.

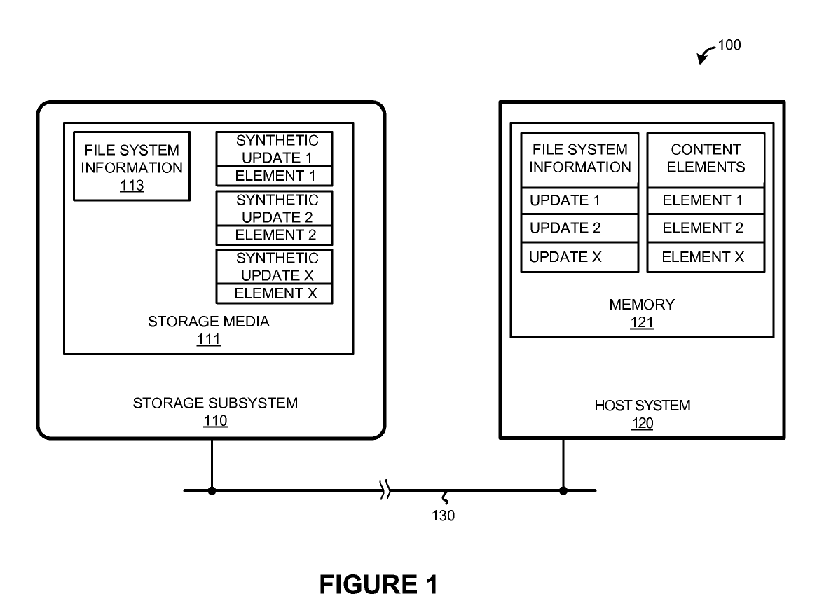

Referring now to the drawings, FIG. 1 is a system diagram illustrating storage control system 100 in one operational embodiment. Storage control system 100 includes storage subsystem 110 and host system 120. Storage subsystem 110 and host system 120 communicate over bus 130. Although bus 130 is shown as one link in FIG. 1, it should be understood that one or more discrete links can be employed between the elements of storage control system 100.

Storage subsystem 110 includes storage media 111. File system information 113, synthetic updates, and content elements are shown to illustrate elements stored on storage media 111. Examples of storage subsystems are hard disk drives, solid state storage devices, tape storage devices, and other mass storage devices, although variations and further elements are possible. Examples of storage media are magnetic rotating media, flash memory, and removable optical media, although variations and further elements are possible. Storage subsystem 110 allows for long-term storage for data even if power is removed. In operation, storage subsystem 110 can store computer-readable data for later retrieval, such as user data, system data, swap file data, and the like.

Host system 120 includes memory 121. File system information, updates, and content elements are shown to illustrate elements stored on memory 121, such as a random access memory found in a computing system, although variations and further elements are possible. Host system 120 can control at least data storage and retrieval operations of storage subsystem 110 over bus 130, as well as control the transfer of data to other systems and equipment, such as to processing systems, network interfaces, and the like.

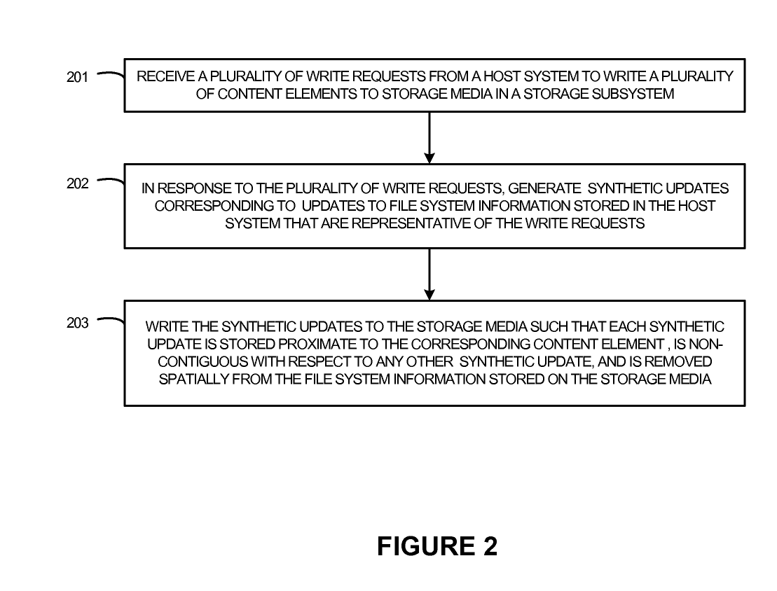

To illustrate example operations for storage control system 100, FIG. 2 is presented. FIG. 2 is a flow diagram illustrating a method of operation of storage control system 100. The operations of FIG. 2 are referenced below parenthetically.

Storage control system 100 receives a plurality of write requests from a host system to write a plurality of content elements to storage media in a storage subsystem (201). When a content element on host system 120 changes, the content element may need to be updated on the storage subsystem. This may be due to a user intentionally saving a file or the application creating an automated backup. Host system 120 will send write requests to the storage subsystem to prepare for writing the content element to the storage subsystem. In this example, content elements are shown as element 1, element 2, and element X in host system 120.

Storage control system 100, in response to the plurality of write requests, generates a plurality of synthetic updates corresponding to a plurality of updates to file system information stored in the host system that are representative of the plurality of write requests (202). As changes are made to content elements, updates are made to the file system information stored in memory on host system 120. Host system 120 may update the file system information or may provide updates appended to the file system information. FIG. 1 show the updates being appended to the file system information. Update 1, update 2, through update X are updates to file system information stored in host system 120 and correspond to the content elements discussed above.

Storage control system 100 writes the plurality of synthetic updates to the storage media such that each synthetic update of the plurality of synthetic updates is stored proximate to the corresponding content element of the plurality of content elements, is non-contiguous with respect to any others of the plurality of synthetic updates, and is removed spatially from a version of the file system information stored on the storage media (203). In some examples, a synthetic update is stored proximate to the content element to reduce write times on hard disk drives. By having the synthetic update either contiguous or within a few tracks, the disk drive head has to move minimally or not at all. Minimizing the movement of the disk drive head improves write speed on a hard disk drive and minimizes emergency power off event corruption.

The synthetic updates can comprise file system information for the particular content element, along with an identifier for the synthetic update. For example, to find a synthetic update after writing the synthetic update, a predetermined string of data can be included in the synthetic update to identify subsequent data as associated with the synthetic update and likewise the content element. In other examples, the synthetic element includes location information for the content element on the storage media.

In another example, a synthetic update is stored proximate to the content element to minimize memory wear on flash memory devices. If the file system information was updated for each content element write, the area of the flash memory device which stores the file system information would wear out and become unusable. A synthetic update stored proximate to the content element on flash memory devices may also improve write times. If the synthetic update and content element are stored in the same block of flash memory, only one block needs to be written rather than two separate blocks. These are just some examples of why a synthetic update would be stored proximate to the content element and other reasons are possible and considered within the scope of the present disclosure. The content element and synthetic update could also be written contiguously to each other. This would allow the storage control system 100 to treat the content element and synthetic update as a continuous block of data to be written.

The synthetic updates are also removed spatially from a version of the file system information stored on storage media 111. Content elements are written throughout storage media 111. Some content elements will be a considerable distance from the version of the file system information stored on storage media 111. Spatially removing the synthetic updates from the file system information allows the content elements and synthetic updates to reside proximate to each other. The storage subsystem may provide for a backup copy of the file system information stored on the storage media. If so, the synthetic updates would also be removed spatially from the backup copy of the file system information.

The synthetic updates and content elements could first be written to a file system journal as journal entries before being written to the appropriate location on the storage media. Once the journal entries have been written, the synthetic updates and content elements can then be written in the appropriate location on the storage media. If an emergency power off event were to happen after the journal entries have been written but before the synthetic updates and content elements have been written, the journal entries may be used to write the synthetic updates and content elements after power has been restored.

The updates to file system information in the host system provide storage control system 100 with information to recreate the file system information in host system 120. Host system 120 or storage subsystem 110 may generate synthetic updates which correspond to the updates to file system information in the host system. Once numerous synthetic updates and content elements have been written to the storage media, the version of file system information on the storage media may be updated. This may occur by writing the updated file system information from host system 120 directly to the file system information on the storage media. Storage control system 100 may also use the synthetic updates written to the storage media to update the version of the file system information on the storage media.

In some examples, storing each synthetic update of the plurality of synthetic updates proximately to the corresponding content element of the plurality of content elements comprises storing each synthetic update of the plurality of synthetic updates in fixed locations throughout the storage media and proximately storing the corresponding content element of the plurality of content elements. The fixed locations can be a plurality of predetermined locations throughout the storage area of the storage media, each predetermined location associated with a location for a synthetic update. The host system can keep a listing of these predetermined locations to speed detection of the synthetic updates across the storage media.

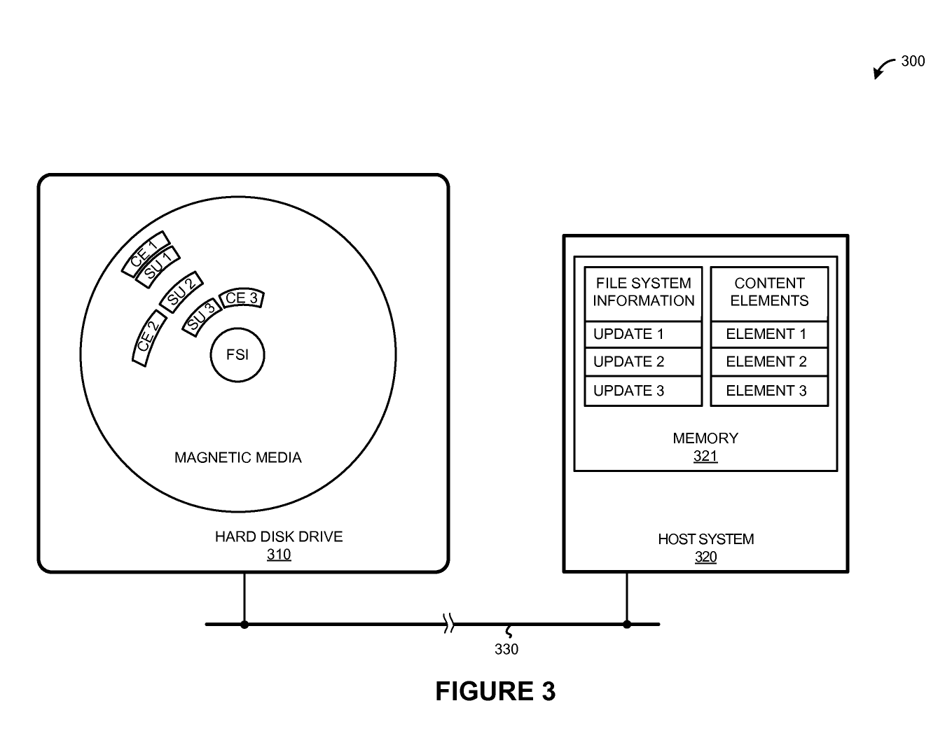

As a further example of a storage control system, FIG. 3 is presented. FIG. 3 is a system diagram illustrating storage control system 300. Storage control system 300 includes hard disk drive 310 and host system 320. Hard disk drive 310 and host system 320 communicate over bus 330. Although bus 330 is shown in FIG. 3, it should be understood that one or more discrete links can be employed between the elements of storage control system 300.

In this example, the content elements and synthetic updates are written to the magnetic media on a hard disk drive. The file system information (FSI) is shown as being recorded on the inner tracks of the magnetic media. Content elements (CE) are shown as CE1, CE2, and CE3 while synthetic updates (SU) are shown as SU1, SU2, and SU3.

Hard disk drive 310 would receive three write requests to write three content elements to the magnetic media. Three synthetic updates would be generated which correspond to the three file system information updates in the host system. In this example, synthetic update 1 is written at the same angular location on the disk as content element 1, but on a different track than content element 1. If synthetic update 1 were written on track 1000, content element 1 may be written on track 1001, 1010, or other proximate location. Synthetic update 2 and 3 are written on the same track as content element 2 and 3; respectively. In one instance, the synthetic update is written before the content element, whereas the other instance writes the synthetic update after the content element.

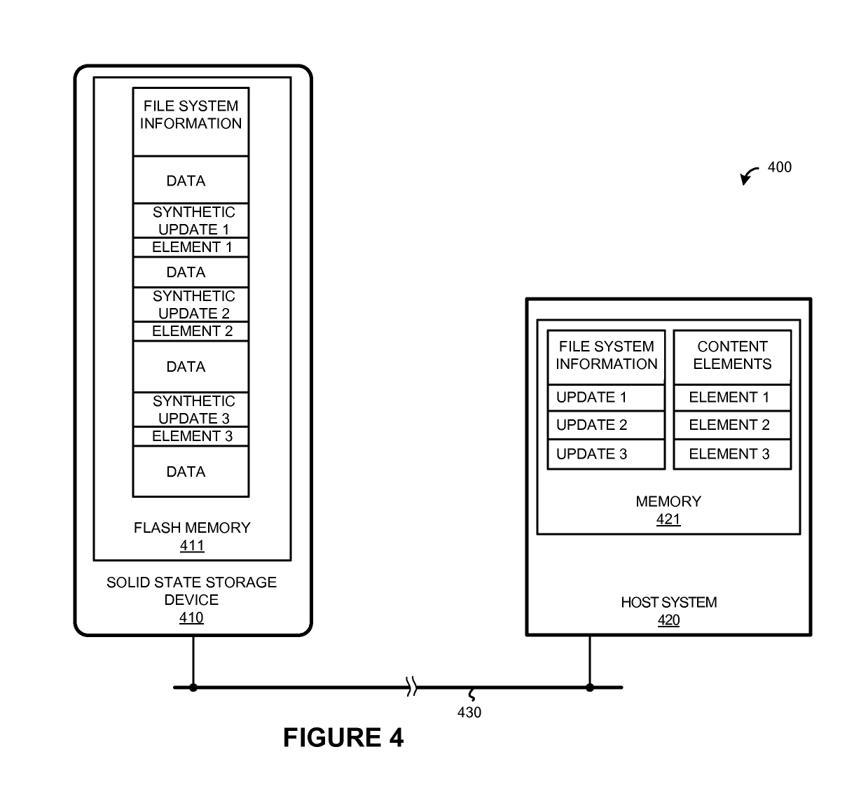

As a further example of a storage control system, FIG. 4 is presented. FIG. 4 is a system diagram illustrating storage control system 400. Storage control system 400 includes solid state storage device 410 and host system 420. Solid state storage device 410 and host system 420 communicate over bus 430. Although bus 430 is shown in FIG. 4, it should be understood that one or more discrete links can be employed between the elements of storage control system 400.

In this example, the content elements and synthetic updates are written to flash memory 411 on solid state storage device 410. The file system information (FSI) is shown as being recorded on the top of the flash memory. Content elements are shown as element 1, element 2, and element 3 while synthetic updates are shown as synthetic update 1, synthetic update 2, and synthetic update 3.

Solid state storage device 410 would receive three write requests to write three content elements to the flash memory. Three synthetic updates would be generated which correspond to the three file system information updates in the host system. In this example, all three synthetic updates are written contiguously with the corresponding content element at different block within the flash memory.

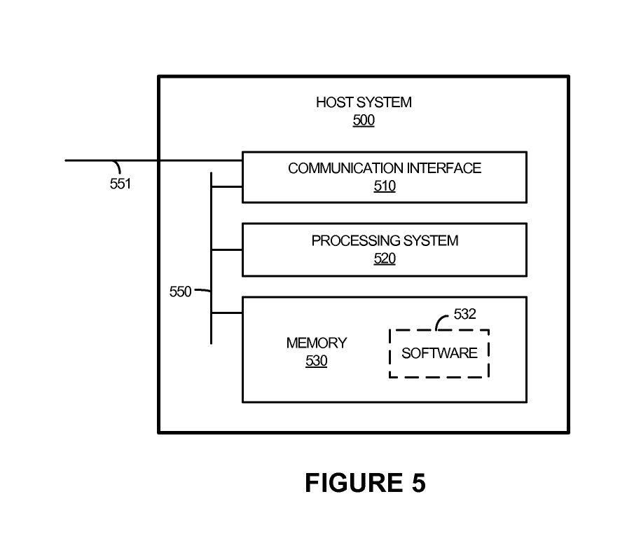

FIG. 5 is a block diagram illustrating host system 500. Host system 500 can include equipment and systems as discussed herein for host system 120 in FIG. 1, host system 320 of FIG. 3, or host system 420 of FIG. 4, although variations are possible. Host system 500 includes communication interface 510, processing system 520, and memory 530. In operation, processing system 520 is operatively linked to communication interface 510 and memory 530 by bus 550. It should be understood that discrete links can be employed, such as network links or other circuitry. Host system 500 can be distributed or consolidated among equipment or circuitry that together forms the elements of host system 500. Host system 500 can optionally include additional devices, features, or functionality not discussed here for purposes of brevity.

Communication interface 510 includes one or more interfaces for communicating with communication networks, data busses, data links, or other devices, such as bus 130 of FIG. 1, bus 330 of FIG. 3, or bus 430 of FIG. 4. The interfaces can include any serial or parallel digital interfaces, or other communication and data interfaces, including combinations, variations, and improvements thereof. Examples of communication interface 510 include logic, transmission gates, buffers, network interface card equipment, transceivers, modems, and other communication circuitry. In this example, communication interface 510 communicates over at least bus 551. Bus 551 can include any communication link as described herein, such as that described for bus 130 of FIG. 1, bus 330 of FIG. 3, or bus 430 of FIG. 4.

Processing system 520 can comprise one or more microprocessors and other circuitry that retrieves and executes software 532 from memory 530. Processing system 520 may be implemented within a single processing device but can also be distributed across multiple processing devices or sub-systems that cooperate in executing program instructions. Examples of processing system 520 include general purpose central processing units, application specific processors, and logic devices, as well as any other type of processing device, combinations, or variations thereof.

Memory 530 may comprise any computer readable storage media readable by processing system 520 and capable of storing software 532. Memory 530 can include volatile and nonvolatile, removable and non-removable media implemented in any method or technology for storage of information, such as computer readable instructions, data structures, program modules, or other data. In addition to storage media, in some implementations, memory 530 can also include communication media over which software 532 can be communicated. Memory 530 can be implemented as a single storage device but can also be implemented across multiple storage devices or sub-systems co-located or distributed relative to each other. Memory 530 can comprise additional elements, such as a controller, capable of communicating with processing system 520. Examples of storage media include random access memory, read only memory, magnetic disks, optical disks, flash memory, virtual memory and non-virtual memory, magnetic cassettes, magnetic tape, magnetic disk storage or other magnetic storage devices, or any other medium which can be used to store the desired information and that can be accessed by an instruction execution system, as well as any combination or variation thereof, or any other type of storage media. In no case is the storage media a propagated signal.

Software 532 may be implemented in program instructions and among other functions can, when executed by host system 500 in general or processing system 520 in particular, direct host system 500 or processing system 520 to transmit write requests to a storage subsystem, generate synthetic updates corresponding to updates to file system information stored in memory 530, transmit content elements to a storage subsystem to be written, among other operations. Software 532 can include additional processes, programs, or components, such as operating system software, database software, or application software. Software 532 may also comprise firmware or some other form of machine-readable processing instructions executable by processing system 520.

Bus 550 comprises a physical, logical, or virtual communication link, capable of communicating data, control signals, and communications, along with other information. In this example, bus 550 also includes elements such as wires, circuit board traces, solid state interconnect, or other elements. In some examples, portions of bus 550 are encapsulated within the elements of host system 500, and can be a software or logical link. In other examples, bus 550 uses various communication media, such as air, space, metal, optical fiber, or some other signal propagation path, including combinations thereof. Bus 550 could be a direct link, or might include various equipment, intermediate components, systems, and networks.

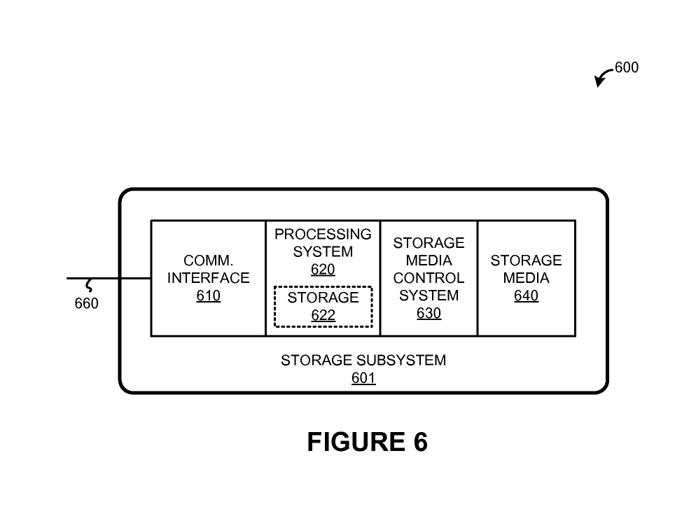

FIG. 6 is a block diagram illustrating storage control device 600. Storage control device 600 may include equipment and systems as discussed herein for storage control device 110 in FIG. 1, storage subsystem 310 in FIG. 3, and storage subsystem 410 in FIG. 4, although variations are possible. Storage control device 600 includes communication interface 610, processing system 620, storage media control system 630, and storage media 640. In operation, processing system 620 is operatively and communicatively linked to communication interface 610, storage media control system 630, and storage media 640. It should be understood that discrete links can be employed, such as individual communication, power, and control links or other circuitry. Storage control device 600 can be distributed or consolidated among equipment or circuitry that together forms the elements of storage control device 600. Storage control device 600 can optionally include additional devices, features, or functionality not discussed here for purposes of brevity.

Communication interface 610 includes one or more interfaces for communicating with communication networks, storage data busses, storage data links, or other devices, such as bus 130 of FIG. 1, bus 330 of FIG. 3, or bus 430 of FIG. 4. The interfaces can include any serial or parallel digital interfaces, or other communication and data interfaces, including combinations, variations, and improvements thereof. Examples of communication interface 610 include logic, transmission gates, buffers, network interface card equipment, transceivers, and other communication circuitry. In this example, communication interface 610 communicates over at least bus 660. Bus 660 can include any communication link as described herein, such as that described for bus 130 of FIG. 1, bus 330 of FIG. 3, or bus 430 of FIG. 4.

Processing system 620 can comprise one or more microprocessors, microcontrollers, application specific integrated circuit (ASIC) processors, or FPGA elements and other circuitry that retrieves and executes firmware from storage system 622. Processing system 620 may be implemented within a single processing device but can also be distributed across multiple processing devices or sub-systems that cooperate in executing program instructions. Examples of processing system 620 include general purpose central processing units, application specific processors, and logic devices, as well as any other type of processing device, combinations, or variations thereof.

Storage system 622 can include any computer readable storage media readable by processing system 620 and capable of storing firmware, such as a computer readable storage device. The computer readable storage media that stores firmware can include volatile and nonvolatile, removable and non-removable media implemented in any method or technology for storage of information, such as computer readable instructions, data structures, program modules, or other data. In addition to storage media, in some implementations the computer readable storage media can also include communication media over which firmware can be communicated. The computer readable storage media that stores firmware may be implemented as a single storage device, but can also be implemented across multiple storage devices or sub-systems co-located or distributed relative to each other. The computer readable storage media that stores firmware may comprise additional elements, such as a controller, capable of communicating with processing system 620. Examples of storage media include random access memory, read only memory, flash memory, or any other medium which can be used to store the desired information and that can be accessed by an instruction execution system, as well as any combination or variation thereof, or any other type of storage media. In no case is the storage media a propagated signal.

Firmware from storage system 622 may be implemented in program instructions and among other functions can, when executed by storage control device 600 in general or storage processor 620 in particular, direct storage control device 600 or storage processor 620 to receive write requests from a host system, generate synthetic updates corresponding to updates to file system information provided by the host system, write synthetic updates proximately to content elements on the storage media, among other operations. Firmware can include additional processes, programs, or components, such as operating system software, database software, or application software. Firmware can also comprise some other form of machine-readable processing instructions executable by storage processor 620.

Storage media control system 630 includes circuitry, devices, and equipment for transferring write data to storage media 640 and reading data from storage media 640. In examples of rotating magnetic media, such as hard disk drives, storage media control system 630 can comprise preamp circuitry, read channel circuitry, servo control systems, channel seek/track systems, write circuitry, step-up voltage converters, buffers, line amplifiers, and other circuitry and equipment.

Storage media 640 comprises a means to store data such as hard disk drive media, flash memory, removable optical media, or the like.

Returning to the elements of FIG. 1, storage subsystem 110 includes one or more computer readable storage media 111. Storage subsystem 110 can include further elements, such as those discussed for storage subsystem 601 in FIG. 6. Storage subsystem 110 can comprise a hard disk drive or other computer readable storage device. The computer readable storage media of storage subsystem 110 could include rotating magnetic storage media, such as shown in FIG. 3, but could also include other media, such as solid state storage media, optical storage media, non-rotating magnetic media, phase change magnetic media, spin-based storage media, or other storage media, including combinations, variations, and improvements thereof.

Host system 120 can include processing elements, data transfer elements, and user interface elements. In some examples, host system 120 is a central processing unit of a computing device or computing system. In other examples, host system 120 also includes memory elements, data storage and transfer elements, controller elements, logic elements, firmware, execution elements, and other processing system components. In yet other examples, host system 120 comprises a RAID controller processor or storage system central processor, such as a microprocessor, microcontroller, Field Programmable Gate Array (FPGA), or other processing and logic device, including combinations thereof. Host system 120 can include, or interface with, user interface elements which can allow a user of storage control system 100 to control the operations of storage control system 100 or to monitor the status or operations of storage control system 100. These user interface elements can include graphical or text displays, indicator lights, network interfaces, web interfaces, software interfaces, user input devices, or other user interface elements. Host system 120 can also include interface circuitry and elements for handling communications over bus 130, such as logic, processing portions, buffers, transceivers, and the like.

Bus 130 can include one or more serial or parallel data links, such as a Peripheral Component Interconnect Express (PCIe) interface, serial ATA interface, Serial Attached Small Computer System (SAS) interface, Integrated Drive Electronics (IDE) interface, ATA interface, Universal Serial Bus (USB) interface, wireless interface, Direct Media Interface (DMI), Ethernet interface, networking interface, or other communication and data interface, including combinations, variations, and improvements thereof. Although bus 130 is shown in FIG. 1, it should be understood that one or more discrete links may be employed between the elements of storage control system 100.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A method of operating a storage control system comprising:
receiving a plurality of write requests from a host system to write a plurality of content elements to storage media in a storage subsystem;
in response to the plurality of write requests, generating a plurality of synthetic updates corresponding to a plurality of updates to file system information stored in the host system that are representative of the plurality of write requests; and
writing the plurality of synthetic updates to the storage media such that each synthetic update of the plurality of synthetic updates is stored proximate to the corresponding content element of the plurality of content elements and is removed spatially from a version of the file system information stored on the storage media.

2. The method of claim 1 comprising:
writing the plurality of synthetic updates to the storage media such that each synthetic update of the plurality of synthetic updates is stored non-contiguous with respect to any others of the plurality of synthetic updates.

3. The method of claim 1 wherein storing each synthetic update of the plurality of synthetic updates proximately to the corresponding content element of the plurality of content elements comprises storing each synthetic update of the plurality of synthetic updates contiguously to the corresponding content element of the plurality of content elements.

4. The method of claim 1 wherein storing each synthetic update of the plurality of synthetic updates proximately to the corresponding content element of the plurality of content elements comprises storing each synthetic update of the plurality of synthetic updates in fixed locations throughout the storage media and proximately storing the corresponding content element of the plurality of content elements.

5. The method of claim 1 further comprising;
updating the version of the file system information stored on the storage media with at least the plurality of updates to file system information stored in the host system.

6. The method of claim 1 further comprising;
updating the version of the file system information stored on the storage media with at least the plurality of synthetic updates stored in the storage media.

7. The method of claim 1 wherein the storage media is an item selected from the group comprising: a hard disk drive, solid state memory, and an optical drive.

8. A storage control system comprising:
a host system configured to generate a plurality of write requests to write a plurality of content elements to storage media in a storage subsystem;
responsive to the plurality of write requests, the host system generates a plurality of synthetic updates corresponding to a plurality of updates to file system information stored in the host system that are representative of the plurality of write request;
the storage subsystem configured to write the plurality of synthetic updates to the storage media such that each synthetic update of the plurality of updates is stored proximate to the corresponding content elements of the plurality of content elements, is non-contiguous with respect to any others of the plurality of synthetic updates, and is removed spatially from a version of the file system information stored on the storage media.

9. The storage control system of claim 8 wherein the storage subsystem is further configured to write the plurality of synthetic updates and the corresponding plurality of content elements to a file system journal on the storage media.

10. A storage control system of claim 8 wherein the storage subsystem is further configured to store each synthetic update of the plurality of synthetic updates contiguously to the corresponding content element of the plurality of content elements.

11. A storage control system of claim 8 wherein the storage subsystem is further configured to store each synthetic update of the plurality of synthetic updates in fixed locations throughout the storage media and proximately store the corresponding content element of the plurality of content elements.

12. A storage control system of claim 8 wherein the storage subsystem is further configured to update the version of the file system information stored on the storage media with at least the plurality of updates to file system information stored in the host system.

13. A storage control system of claim 8 wherein the storage subsystem is further configured to update the version of the file system information stored on the storage media with at least the plurality of synthetic updates stored in the storage media.

14. A storage subsystem comprising:
a communication interface configured to receive a plurality of write requests to write a plurality of content elements to storage media in the storage subsystem;
responsive to the plurality of write requests, the communication interface further configured to receive a plurality of synthetic updates corresponding to a plurality of updates to file system information stored in a host system that are representative of the plurality of write request;
a processing system configured to write the plurality of synthetic updates to the storage media such that each synthetic update of the plurality of updates is stored proximate to the corresponding content elements of the plurality of content elements and is removed spatially from a version of the file system information stored on the storage media.

15. The storage subsystem of claim 14 comprising:
the processing system configured to write the plurality of synthetic updates to the storage media such that each synthetic update of the plurality of updates is stored non-contiguous with respect to any others of the plurality of synthetic updates.

16. The storage subsystem of claim 14 wherein the processing system is further configured to store each synthetic update of the plurality of synthetic updates contiguously to the corresponding content element of the plurality of content elements.

17. The storage subsystem of claim 14 wherein the processing system is further configured to store each synthetic update of the plurality of synthetic updates in fixed locations throughout the storage media and proximately store the corresponding content element of the plurality of content elements.

18. The storage subsystem of claim 14 wherein the processing system is further configured to update the version of the file system information stored on the storage media with at least the plurality of updates to file system information stored in the host system.

19. The storage subsystem of claim 14 wherein the processing system is further configured to update the version of the file system information stored on the storage media with at least the plurality of updates to file system information stored in the host system.

20. The storage subsystem of claim 14 wherein the storage media is an item selected from the group comprising: a hard disk drive, solid state memory, and an optical drive.
